(19) United States
(12) Patent Application Publication
(10) Pub. No.: US 2007/0054666 A1
(43) Pub. Date: Mar. 8, 2007

(54) Method and apparatus of inter-PLMN cell re-selection in a mobile communication terminal

(75) Inventor: Kwang-Hae Choi, Seongnam-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/504,902

(22) Filed: Aug. 16, 2006

(30) Foreign Application Priority Data
Sep. 5, 2005 (KR) 2005-0082256

(51) Int. Cl. H04Q 7/20

(52) U.S. Cl. 455/434

(57) ABSTRACT

A method and apparatus of performing an inter-PLMN (Public Land Mobile Network) cell reselection in a mobile communication terminal is disclosed. The invention includes checking whether system information including another PLMN BCCH (Broadcast Control CHannel) allocation list and an inter-PLMN cell reselection offset value is received and determining a reselection target cell using the received inter-PLMN cell reselection offset value when an inter-PLMN cell reselection is needed. Thus, network signaling caused by inter-PLMN location updating may be reduced.

### PRIORITY

This application claims priority under 35 U.S.C. § 119 to an application entitled “Method Of BCCH (Broadcast Control CHannel) Frequency Management For Cell Re-selection In A Mobile Communication Terminal” filed in the Korean Intellectual Property Office on Sep. 5, 2005 and assigned Serial No. 2005-82256, the contents of which are incorporated herein by reference.

### BACKGROUND OF THE INVENTION

1. Field of the Invention

The present invention relates to a method and apparatus for cell reselection in a mobile communication terminal, in particular, to a method for performing inter-PLMN (Public Land Mobile Network) target cell reselection by using another PLMN BCCH (Broadcast Control CHannel) allocation list and a inter-PLMN cell reselection offset value included in system information transmitted from a base station.

2. Description of the Related Art

FIG. 1 is a block diagram of a conventional mobile communication system.

Referring to FIG. 1, a mobile communication terminal 101 connects to a base station (e.g., base station 103) having the strongest reception signal among a plurality of base stations 103, 104 and 105 in a mobile communication system. When an originating number is dialed by a user's key manipulation, identity values such as TMSI (Temporary Mobile Subscriber Identity) and IMEI (International Mobile Equipment Identity) are transmitted for authentication. After this, the mobile communication terminal 101 is call-connected to a base station of another mobile communication terminal via an MSC (mobile switching center) 109 connected to a base station controller 107 managing each base station 103, 104 and 105. Also, after the mobile switching center 109 identifies a subscriber through an AUC (AUthentication Center) 111, the base station 103 transmits a channel allocation message to the mobile communication terminal 101, and the mobile communication terminal 101 starts to call using the allocated channel.

If the mobile communication terminal 101 is connected to the base station 103, the base station 103 transmits a BCCH (Broadcast Control CHannel) frequency of its PLMN using system information types 2, 2bis, 2ter and 2quater in an idle state to the mobile communication terminal 101.

When the mobile communication terminal 101 performs cell reselection, only inter-PLMN cell reselection is generated. Also, the mobile communication terminal 101 has an offset so as to generate the inter LA (Location Area) cell reselection less than intra LA cell reselection in the same PLMN.

Recently, due to providing combined service with another switching center network or due to a merge between PLMNs, the terminal has to perform an inter-PLMN cell reselection in an idle state.

Accordingly, a method for providing inter-PLMN cell reselection is needed in a mobile communication terminal.

### SUMMARY OF THE INVENTION

Accordingly, an object of the present invention is to provide a method of performing inter-PLMN cell reselection in a mobile communication terminal.

Another object of the present invention is to provide a method of receiving system information including other PLMN BA (Broadcast control channel Allocation) list and an inter-PLMN cell reselection offset value from a base station for performing inter-PLMN cell reselection in a mobile communication terminal.

Another object of the present invention is to provide a method of receiving 2quater rest octets type system information including the other PLMN BA list and an inter-PLMN cell reselection offset value from a base station for performing inter-PLMN cell reselection in a mobile communication terminal.

According to an aspect of the present invention for achieving the above objects, in a method for performing inter-PLMN cell reselection in a mobile communication terminal, it is determined whether the terminal receives system information including other PLMN BA (Broadcast control channel Allocation) list and an inter-PLMN cell reselection offset information. When it is determined that cell reselection is required, a reselection target cell is determined by using the received inter-PLMN cell reselection offset value.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram in a conventional mobile communication system;

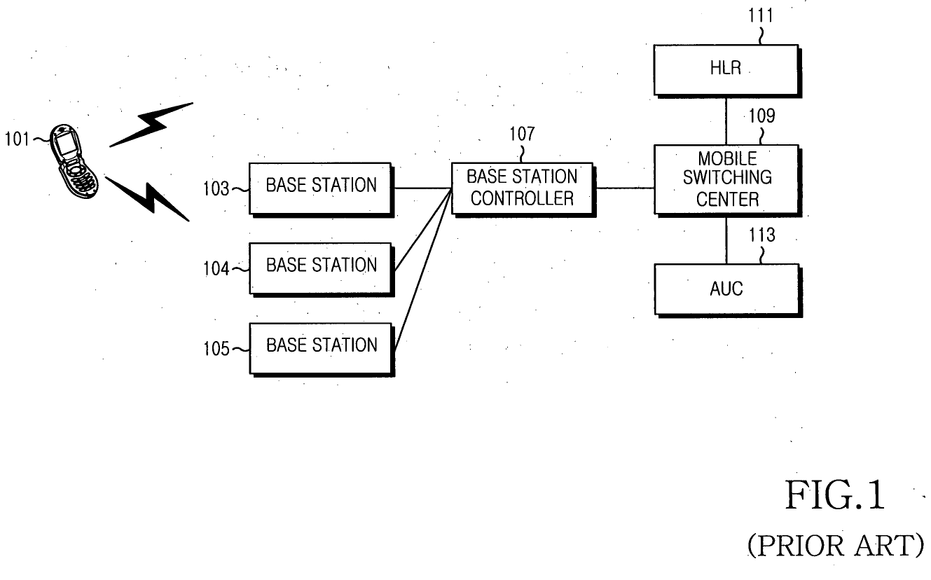

FIG. 2 illustrates a procedure of inter-PLMN cell reselection according to the present invention; and

FIG. 3 is an illustration showing 2quater rest octets type system information configuration including other PLMN BA list and an inter-PLMN cell reselection offset value according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail.

Hereinafter, it is described that a technology for performing inter-PLMN cell reselection in a mobile communication terminal using system information including another PLMN (Public Land Mobile Network) BA (BCCH Frequency Allocation) list and an inter-PLMN cell reselection offset value from a base station. It is assumed that the other PLMN BA list and an inter-PLMN cell reselection offset is transmitted by using 2quater rest octets type system information among types being used for BCCH (Broadcast Control Channel) frequency information transmission, i.e., 2, 2bis, 2ter and 2quater. Here, because content of the system information type 2quater is in the section 9.1.34a.1 Table included in the 3GPP TS 44.018, standard a detailed description will be omitted.

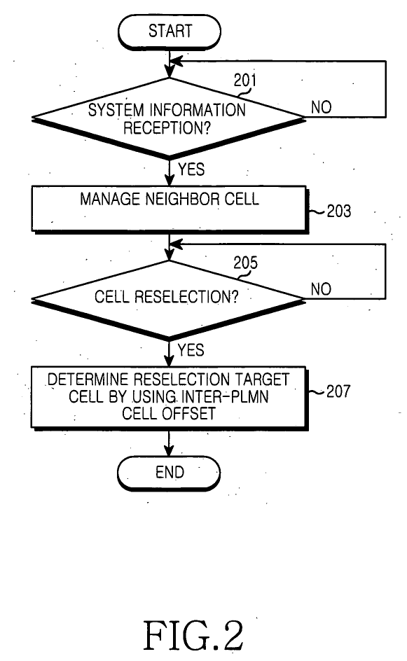

FIG. 2 illustrates a procedure of inter-PLMN cell reselection according to the present invention.

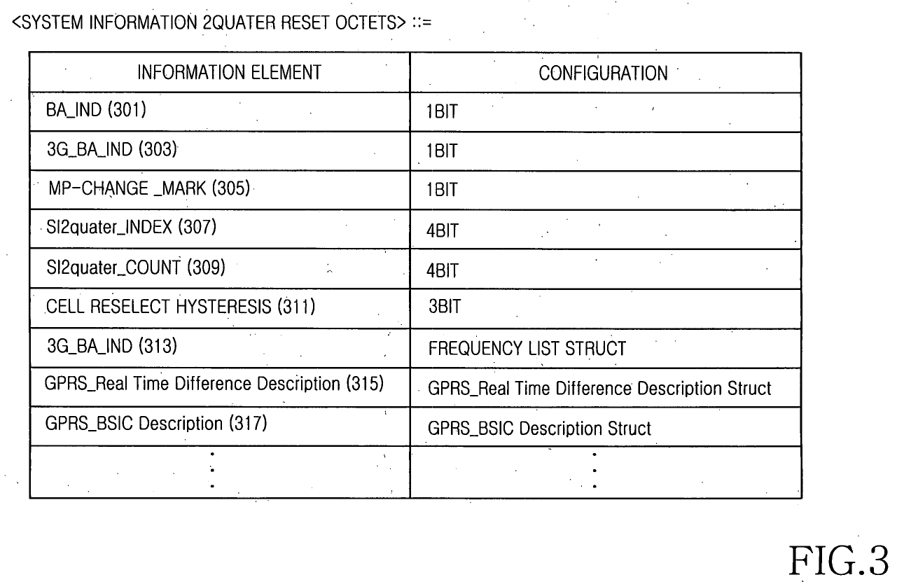

Referring to FIG. 2, a mobile communication terminal checks if system information transmitted from a base station in an idle state is received in step 201. Here, the received system information includes other PLMN BA list information and an inter-PLMN cell reselection offset. The system information type is 2quater rest octets. For example, as illustrated in FIG. 3, a CELL RESELECT HYSTERESIS 311 and an Other PLMN Frequency List 313 are inserted in 2quater rest octets in order to include the inter-PLMN cell reselection offset and other PLMN BA list information.

When the system information is received, the mobile terminal proceeds to step 203 to manage an inter-PLMN cell separately from the intra-PLMN cell management.

After this, the mobile terminal proceeds to step 205 to determine if an inter-PLMN cell reselection is needed. The inter-PLMN cell reselection is needed when a wireless circuit failure occurs or a network requirement requires, or a traffic load beyond a threshold occurs, or a user requirement requires. Whether the inter-PLMN cell reselection is needed is determined by comparing a status of the serving cell and a status of a neighbor cell.

If the cell reselection is needed, the terminal proceeds to step 207 to determine an inter-PLMN reselection target cell. Next, the mobile communication terminal ends this algorithm. The inter-PLMN reselection target cell is determined using the inter-PLMN offset value included in the received system information. Thus, the inter-PLMN cell reselection is controlled by an inter-PLMN cell reselection offset value.

FIG. 3 is an illustration showing 2quater rest octets type system information configuration including another PLMN BA list and an inter-PLMN cell reselection offset value according to the present invention.

Referring to FIG. 3, 2quater rest octets type system information includes a BA_IND 301, a 3G_BA_IND 303, a MP_CHANGE_MARK 305, a SI2quater_INDEX 307, a SI2quater_COUNT 309, a CELL RESELECT HYSTERESIS 311, a 3G-BA-IND 313, a GPRS_Real Time Difference Description 315 and a GPRS_BSIC Description 317.

The BA_IND 301 indicates a BCCH allocation sequence number and allows to distinguish measurements results related to different GSM (Global Positioning Mobile) Neighbor Cell lists. The 3G_BA_IND 303 indicates a 3G BCCH allocation sequence number and sets of 3G Neighbor Cell information.

The MP_CHANGE_MARK 305 is changed each time Measurement Information or 3G Measurement Information has been updated. The SI2quater_INDEX 307 is used to distinguish individual SI2quarter messages. The SI2quater_COUNT 309 represents an index value of the SI2quater_INDEX 307 in binary code.

The CELL RESELECT HYSTERESIS 311 represents an inter-PLMN cell reselection offset value. 3G-BA-IND 313 is field containing another PLMN BA (BCCH Allocation) list. The GPRS_Real Time Difference Description 315 is used for GPRS neighbor cell measurement when the cell has no PBCCH (Packet Broadcast Control CHannel) allocated. The GPRS_BSIC Description 317 is used for measuring and reporting GPRS Enhanced (NC) when the cell has no PBCCH allocated.

The above method performs an inter-PLMN cell reselection using an inter-PLMN reselection offset value included in the system information. The transmitting system information including the other PLMN BA list and an inter-PLMN reselection offset value from the base station to the mobile terminal is performed in an idle state.

As another example, system information including the other PLMN BA list and an inter-PLMN reselection offset value may be transmitted in an inter-PLMN handover dedicated mode. In this case, multiple PLMN reports may be defined by adding other PLMN cell reports in a measurement report of an inter-PLMN handover dedicated mode.

As described above, the inter-PLMN cell reselection is controlled using the other PLMN BA list and an inter-PLMN cell reselection offset value included in the system information transmitted to a mobile communication terminal. Therefore, intra-PLMN cell reselection is more likely to be generated than the inter-PLMN cell reselection. Thus, network signaling caused by inter-PLMN location updating may be reduced. Also, it can be induced to a preferred inter-PLMN cell reselection by adjusting the inter-PLMN cell reselection offset value.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method of performing an inter-PLMN (Public Land Mobile Network) cell reselection in a mobile communication terminal, comprising the steps of:
checking whether system information including another PLMN BCCH (Broadcast Control CHannel) allocation list and an inter-PLMN cell reselection offset value is received; and
determining an inter-PLMN reselection target cell using the received inter-PLMN cell reselection offset value when inter-PLMN cell reselection is needed.

2. The method of claim 1, wherein the system information is received in an idle state.

3. The method of claim 1, wherein the system information includes the other PLMN BCCH (Broadcast Control CHannel) allocation list in a CELL RESELECT HYSTERESIS field and the inter-PLMN cell reselection offset value in an Other PLMN Frequency List field.

4. The method of claim 3, wherein the system information including the CELL RESELECT HYSTERESIS field and the Other PLMN Frequency List field is 2quater rest octets.

5. The method of claim 1, wherein when the inter-PLMN cell reselection is needed is determined by comparing a status of a serving cell and a status of a neighbor cell.

6. A method of performing an inter-PLMN (Public Land Mobile Network) cell reselection in a mobile communication terminal, comprising the steps of:
checking whether system information including another PLMN BCCH (Broadcast Control CHannel) allocation list and an inter-PLMN cell reselection offset value is received; and
performing an inter-PLMN target cell reselection using the received inter-PLMN cell reselection offset value.

7. The method of claim 6, wherein the system information is received in an idle state.

8. The method of claim 6, wherein the system information includes the other PLMN BCCH (Broadcast Control CHannel) allocation list in a CELL RESELECT HYSTERESIS field and the inter PLMN cell reselection offset value in an Other PLMN Frequency List field.

9. The method of claim 6, wherein the system information including the CELL RESELECT HYSTERESIS field and the Other PLMN Frequency List field is 2quater rest octets.

10. A method of performing an inter PLMN (Public Land Mobile Network) cell reselection in a mobile communication terminal, comprising the steps of:
checking whether system information including another PLMN BCCH (Broadcast Control CHannel) allocation list and an inter-PLMN cell reselection offset value is received in an inter-PLMN handover dedicated mode; and
performing an inter-PLMN target cell reselection using the received inter-PLMN cell reselection offset value.

11. The method of claim 10, wherein the system information includes the other PLMN BCCH (Broadcast Control CHannel) allocation list in a CELL RESELECT HYSTERESIS field and the inter PLMN cell reselection offset value in an Other PLMN Frequency List field.

12. The method of claim 10, wherein the system information including the CELL RESELECT HYSTERESIS field and the Other PLMN Frequency List field is 2quater rest octets.

13. A mobile communication terminal for performing an inter-PLMN (Public Land Mobile Network) cell reselection, comprising:
checking means for checking whether system information including another PLMN BCCH (Broadcast Control CHannel) allocation list and an inter-PLMN cell reselection offset value is received; and
determining means for determining an inter-PLMN reselection target cell using the received inter-PLMN cell reselection offset value when inter-PLMN cell reselection is needed.

14. The mobile communication terminal of claim 13, wherein the system information is received in an idle state.

15. The mobile communication terminal of claim 13, wherein the system information includes the other PLMN BCCH (Broadcast Control CHannel) allocation list in a CELL RESELECT HYSTERESIS field and the inter-PLMN cell reselection offset value in an Other PLMN Frequency List field.

16. The mobile communication terminal of claim 13, wherein when the inter-PLMN cell reselection is needed is determined by comparing a status of a serving cell and a status of a neighbor cell.

17. A mobile communication terminal of performing an inter-PLMN (Public Land Mobile Network) cell reselection, comprising:
checking means for checking whether system information including another PLMN BCCH (Broadcast Control CHannel) allocation list and an inter-PLMN cell reselection offset value is received; and
performing means for performing an inter-PLMN target cell reselection using the received inter-PLMN cell reselection offset value.

18. A mobile communication terminal of performing an inter PLMN (Public Land Mobile Network) cell reselection, comprising:
checking means for checking whether system information including another PLMN BCCH (Broadcast Control CHannel) allocation list and an inter-PLMN cell reselection offset value is received in an inter-PLMN handover dedicated mode; and
performing means for performing an inter-PLMN target cell reselection using the received inter-PLMN cell reselection offset value.
